(19) United States
(12) Patent Application Publication
(10) Pub. No.: US 2025/0289724 A1
(43) Pub. Date: Sep. 18, 2025

(54) AMMONIA CONVERTER FOR VARYING PARTIAL LOAD OPERATION

(71) Applicants: thyssenkrupp Uhde GmbH, Dortmund (DE); thyssenkrupp AG, Essen (DE)

(72) Inventor: Evgeni GORVAL, Dortmund (DE)

(73) Assignees: thyssenkrupp Uhde GmbH, Dortmund (DE); thyssenkrupp AG, Essen (DE)

(21) Appl. No.: 18/860,534

(22) PCT Filed: Apr. 26, 2023
(86) PCT No.: PCT/EP2023/060941

§ 371 Date: Oct. 25, 2024

(30) Foreign Application Priority Data
Apr. 27, 2022 (BE) BE 2022/5308
Apr. 27, 2022 (DE) 10 2022 204 104.6

(51) Int. Cl. C01C 1/04; B01J 8/02; B01J 8/04

(52) U.S. Cl. CPC C01C 1/0417; B01J 8/0214; B01J 8/0496; B01J 2208/00132; B01J 2208/00548; B01J 2208/027

(57) ABSTRACT

An ammonia converter comprises a casing, a starting material inlet and a product outlet, a first catalyst bed and a second catalyst bed, wherein the flow passes through the first catalyst bed and the second catalyst bed radially from the outside to the center, a tube bundle heat exchanger, wherein the tube bundle heat exchanger has a central tube and a plurality of heat exchanging tubes, wherein the heat exchanging tubes are arranged parallel to the central tube and around the central tube, wherein the tube bundle heat exchanger is surrounded in a ring shape by the first catalyst bed, wherein the heat exchanger is a co-current flow heat exchanger, which is configured in such a way that, in said heat exchanger, the gas flow through the heat exchanging tubes is guided in the same direction as the gas flow flowing around the heat exchanging tubes, wherein the starting material inlet is directly connected to the heat exchanging tubes in terms of gas flow, wherein the central tube is directly connected to the space between the casing and the first catalyst bed in terms of gas flow.

The invention relates to an ammonia converter which is configured to work reliably, even with varying degrees of utilization. Varying loads occur, for example, when the hydrogen is generated by means of electrolysis using regeneratively generated energy, for example, and hence the starting materials available are also subject to great variation, depending on the weather.

EP 3 497 392 B2 discloses the use of a plate heat exchanger and of a synthesis device for the production, in particular, of ammonia.

EP 3 497 058 B1 discloses a synthesis device and a method for the production, in particular, of ammonia.

Energy is released during ammonia synthesis on account of the conversion process. The higher the temperature, however, the more the equilibrium shifts toward the starting materials. And if the temperature exceeds a certain level, there may of course also be damage to the device. Conversion therefore generally takes place in two or more stages. Between two stages, the excess energy is transferred to cooler inflowing starting material by means of a heat exchanger.

For normal synthesis, the heat exchanger is designed for maximum efficiency since this enables it to be of particularly small configuration, which, in turn, allows more catalyst in the converter, this in turn increasing conversion.

If a conventional converter is then supplied with a varying flow of starting material, it may happen that the flow of starting material cools the product flow to such an extent that said product flow is no longer hot enough for further conversion at the next stage, being below 370° C. for example, and the reaction comes to a halt. However, if the heat exchanger were then to be made smaller, either the cold incoming gas would not be adequately heated, and the reaction would therefore come to a halt, or, at full load, the converter could be overheated and thus damaged since the gas emerging from the preceding stage would not be sufficiently cooled (for example to a temperature below about 525° C.).

It is the object of the invention to provide a converter which works reliably both when under full load and under minimum partial loads.

This object is achieved by the ammonia converter having the features specified in claim 1. Advantageous further developments will become apparent from the dependent claims, the following description and the drawing.

The ammonia converter according to the invention has a casing. The casing is appropriate for the high pressures that are customary for ammonia synthesis and, at the same time, it must be configured for the hydrogen-containing atmosphere and elevated temperatures. The ammonia converter furthermore has a starting material inlet and a product outlet. Additional secondary starting-material inlets can be provided in order, for example, to enable cool starting gas mixture to be fed directly, for example, to the second catalyst bed in order, for example, to enable the temperature to be controlled by this means. The mixture of hydrogen and nitrogen (optionally with further components such as ammonia or argon) is fed in via the starting material inlet. Via the product outlet, the product gas mixture consisting of ammonia, hydrogen and nitrogen is removed from the ammonia converter. The ammonia converter has at least a first catalyst bed and a second catalyst bed. Within the catalyst beds, the conversion of hydrogen and nitrogen to ammonia takes place at the surface of the catalyst. The flow passes through the first catalyst bed and the second catalyst bed radially from the outside to the center. The gas mixture to be converted is thus fed to the catalyst bed from the outside from a space between the casing and the catalyst bed. The gap between the casing and the catalyst bed is used for distribution of the gas mixture along the catalyst bed. The ammonia converter has at least one heat exchanger (first heat exchanger). The heat exchanger is in the form of a tube bundle heat exchanger (first tube bundle heat exchanger). The tube bundle heat exchanger has a central tube and a plurality of heat exchanging tubes. The flow through the heat exchanging tubes is in the opposite direction to the flow through the central tube. The heat exchanging tubes are arranged parallel to the central tube and around the central tube. The heat exchanging tubes thus surround the central tube. The tube bundle heat exchanger has a deflection device. The deflection device is arranged between the heat exchanging tubes and the central tube in terms of flow and is configured to guide the gas flow out of the heat exchanging tubes into the central tube. As a result, the flow through the central tube is in the opposite direction in comparison with the direction of flow through the heat exchanging tubes. The tube bundle heat exchanger is surrounded in a ring shape by the first catalyst bed, thus being arranged in the inner core of the first catalyst bed. As a result, the gas mixture heated by the reaction in the first catalyst bed is fed to the tube bundle heat exchanger and thus heats the gas mixture inside the tubes.

According to the invention, the starting material inlet is directly connected to the heat exchanging tubes in terms of gas flow, and the central tube is directly connected to the space between the casing and the first catalyst bed in terms of gas flow. The statement that the starting material inlet is directly connected to the heat exchanging tubes in terms of gas flow means, in particular, that the central first tube is in fact not arranged between the starting material inlet and the heat exchanging tubes. Likewise, the statement that the central tube is directly connected to the space between the casing and the first catalyst bed in terms of flow means that the heat exchanging tubes are in fact not arranged between the central tube and the space between the casing and the first catalyst bed. As a result, the heat exchanger is a co-current flow heat exchanger, in which the gas flow through the heat exchanging tubes is guided in the same direction as the gas flow flowing around the heat exchanging tubes. In conventional converters, the heat exchanger is operated as a countercurrent flow heat exchanger since this reduces the size of the heat exchanger, which, in turn, increases the quantity of catalyst and thus the maximum plant capacity. A co-current flow heat exchanger thus appears inefficient. However, co-current flow heat exchangers have a technical advantage. By virtue of the co-current flow, the two gas flows have the same temperature at the outlet in the case of maximum heat transfer. As a result, it is impossible for an excessive amount of heat to be transferred: both gas flows have the temperature required to continue conversion of each of the gas flows when they are fed to the next catalyst bed and thus to maintain the reaction. Maximum flexibility for partial loads is thus achieved at the expense of a certain proportion of the maximum capacity, and the ammonia converter is therefore ideal for use in generating “green ammonia” by means of regeneratively generated energy.

In another embodiment of the invention, the ammonia converter has a third catalyst bed. The third catalyst bed is arranged between the first catalyst bed and the second catalyst bed. The heat exchanger has a first partial heat exchanger and a second partial heat exchanger. The first partial heat exchanger is surrounded in a ring shape by the first catalyst bed, and the second partial heat exchanger is surrounded in a ring shape by the third catalyst bed. The path of the gas flow is thus from the starting material inlet, through the heat exchanger, to be more precise through the heat exchanging tubes of the first partial heat exchanger, then through the heat exchanging tubes of the second partial heat exchanger, and then through the central tube. From there, the gas flow is guided between the casing and the first catalyst bed and then through the first catalyst bed. From there, it flows via the heat exchanger (to be more precise, along the outside of the heat exchanging tubes of the first partial heat exchanger of the heat exchanger), between the casing and the third catalyst bed, and is then passed through the third catalyst bed. From there, it flows via the heat exchanger (to be more precise, along the outside of the heat exchanging tubes of the second partial heat exchanger of the heat exchanger), between the casing and the second catalyst bed, and is then passed through the second catalyst bed. The gas flow is then passed through the product outlet.

In another embodiment of the invention, the total surface area of the heat exchanging tubes is configured for sufficient heat transfer for a partial-load circulating gas quantity of 10% of the maximum circulating gas quantity at full load. Heat transfer is regarded as “sufficient”, in particular, when the temperature of the cold incoming gas that has been achieved and the temperature of the hot outgoing gas that has been achieved before entry to a subsequent catalyst bed are in a suitable range. This can be the case especially when, given the respective flow rates, the total surface area of the heat exchanging tubes is sufficiently large to enable a heat transfer with which the cold incoming gas is heated sufficiently to ensure that the temperature of the heated gas maintains a reaction in the first catalyst bed, even with the smaller quantity of circulating gas that occurs in partial load operation. On the other hand, the temperature of the hot gas downstream of the (partial) heat exchanger must not, for example, exceed a maximum value, for example a value of about 410° C.; the dimensioning and design of suitable heat exchanging tubes for the respective plant capacity are sufficiently well known to a person skilled in the art. In this process, fundamentally different operating states of the plant are taken into account, including operation under full load and under different partial loads. The partial loads include, inter alia, also the limiting case with a partial circulating quantity of 10% of the maximum circulating gas quantity at full load, wherein the molar flow rate of the circulating gas (i.e. the molar flow rate at the inlet to the converter) is reduced to a value of 10% as compared with normal operation (100%). Admittedly, the smaller the possible partial load, the larger the heat exchanger must be made to prevent the converter from overheating at full load because the gas emerging from the preceding stage is not sufficiently cooled. On the other hand, however, the ammonia converter can continue to be operated even when the quantities of available regenerative energy are small, thus reducing downtimes, which, in turn, avoids high-loss start-ups.

In another embodiment of the invention, the ammonia converter has a maximum plant capacity of 50 to 700 tonnes of ammonia per day. The maximum plant capacity is a basic variable for the dimensioning of ammonia converters, for which reason it is the decisive variable for the ordering, planning and design of an ammonia converter. The invention is therefore particularly preferred for relatively small ammonia synthesis plants. Conventional plants achieve a capacity of 3000 tonnes per day and above. However, if use is to be made of regenerative energy sources, these are subject, on the one hand, to change over time. On the other hand, generation is also usually limited, for example on account of the available space for solar or wind power installations. It can therefore be assumed that plants which are being planned for the generation of green ammonia are more likely to require relatively small converters. However, this is where there is synergy with the invention. Since the converter is constructed in a pressure-stable casing, these are generally of a certain size. This has the effect that there is additional space available in the converter in the case of relatively small plants. As a result, the disadvantage of the increased space requirement for the heat exchanger according to the invention does not constitute a negative factor.

In another embodiment of the invention, on the side around which the gas emerging from the first catalyst bed flows, on the heat exchanger, radially arranged guide elements are arranged for generating a flow that crosses the heat exchanging tubes. Exchange is optimized by this zigzag routing.

The ammonia converter according to the invention is explained in greater detail below with reference to an exemplary embodiment illustrated in the drawing.

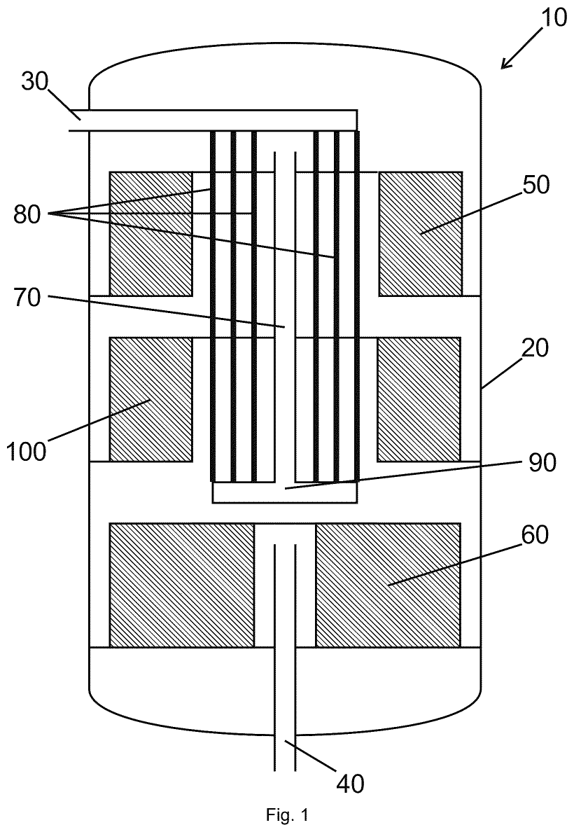

FIG. 1 Ammonia converter

FIG. 1 shows an illustrative ammonia converter 10 in schematic cross section. The illustration is not to scale and serves to clarify the invention.

A mixture of hydrogen and nitrogen is fed in via a starting material inlet 30. The gas mixture is passed into the heat exchanging tubes 80 and flows downward in said tubes, being heated in the process. The heated gas mixture from the heat exchanging tubes 80 is brought together by means of the deflection device 90 and guided into the central tube 70. There, the gas mixture flows upward and then passes via the upper region into the gap between the casing 20 and the first catalyst bed 50. There, the gas flow is passed radially through the first catalyst bed 50, where it is converted, heating up in the process. The gas flow emerging from the first catalyst bed 50 releases its excess heat to the heat exchanging tubes 80 by flowing around the heat exchanging tubes 80 in the same direction of flow in which the starting gas mixture flows through the heat exchanging tubes 80, and is guided into the gap between the casing 20 and the third catalyst bed 100. There, the gas flow is passed radially through the third catalyst bed 100, where it is converted, heating up in the process. The gas flow emerging from the third catalyst bed 100 releases its excess heat to the heat exchanging tubes 80 and is guided into the gap between the casing 20 and the second catalyst bed 60. There, the gas flow is passed radially through the second catalyst bed 60, where it is converted, heating up in the process. The gas flow emerging from the second catalyst bed 60 is passed to the product outlet 40.

### Reference Signs

10 ammonia converter
20 casing
30 starting material inlet
40 product outlet
50 first catalyst bed
60 second catalyst bed
70 central tube
80 heat exchanging tube
90 deflection device
100 third catalyst bed

1-5. (canceled)

6. An ammonia converter, comprising:
a casing,
a starting material inlet and a product outlet,
a first catalyst bed and a second catalyst bed, wherein the flow passes through the first catalyst bed and the second catalyst bed radially from the outside to the center, and
at least one tube bundle heat exchanger, wherein the tube bundle heat exchanger includes:
a central tube and a plurality of heat exchanging tubes, wherein the heat exchanging tubes are arranged parallel to the central tube and around the central tube, and
a deflection device arranged between the heat exchanging tubes and the central tube in terms of flow,
wherein the tube bundle heat exchanger is surrounded in a ring shape by the first catalyst bed such that the gas mixture heated by the reaction in the first catalyst bed is fed to the tube bundle heat exchanger and thus heats the gas mixture inside the heat exchanging tubes,
wherein the tube bundle heat exchanger is a co-current flow heat exchanger, which is configured in such a way that, in said heat exchanger, the gas flow through the heat exchanging tubes is guided in the same direction as the gas flow flowing around the heat exchanging tubes,
wherein the starting material inlet is directly connected to the heat exchanging tubes in terms of gas flow,
wherein the deflection device is configured to guide the gas flow out of the heat exchanging tubes into the central tube, such that the flow through the central tube is in the opposite direction to the flow through the heat exchanging tubes,
wherein the central tube is directly connected to the space between the casing and the first catalyst bed in terms of gas flow.

7. The ammonia converter as claimed in claim 6, wherein the ammonia converter has a third catalyst bed, wherein the tube bundle heat exchanger has a first partial heat exchanger and a second partial heat exchanger, wherein the first partial heat exchanger is surrounded in a ring shape by the first catalyst bed, wherein the second partial heat exchanger is surrounded in a ring shape by the third catalyst bed.

8. The ammonia converter as claimed in claim 6, wherein the total surface area of the heat exchanging tubes is configured for sufficient heat transfer for a partial-load circulating gas quantity of 10% of the maximum circulating gas quantity at full load.

9. The ammonia converter as claimed in claim 6, wherein the ammonia converter has a maximum plant capacity of 50 to 700 tonnes of ammonia per day.

10. The ammonia converter as claimed in claim 6, wherein, on the side around which the gas emerging from the first catalyst bed flows, on the heat exchanger, radially arranged guide elements are arranged for generating a flow that crosses the heat exchanging tubes.
